(19) United States
(12) Patent Application Publication
(10) Pub. No.: US 2013/0170129 A1
(43) Pub. Date: Jul. 4, 2013

(54) SYSTEMS AND METHODS FOR PROVIDING A DYNAMIC ELECTRONIC STORAGE UNIT

(71) Applicant: Jason A. Sullivan, Youngstown, OH (US)

(72) Inventor: Jason A. Sullivan, Youngstown, OH (US)

(21) Appl. No.: 13/674,032

(22) Filed: Nov. 10, 2012

Related U.S. Application Data
(60) Provisional application No. 61/558,420, filed on Nov. 10, 2011.

(51) Int. Cl. G06F 1/18

(52) U.S. Cl. CPC G06F 1/185
USPC 361/679.32

(57) ABSTRACT

The present invention relates to a modular electronic storage unit. The unit includes an electronic circuit board riser. An electronic storage card having a storage device is removably coupled to the electronic circuit board riser and is in communication with the electronic circuit board riser. A controller is couple to the electronic circuit board rise that provides support for communicating between the electronic storage card and an external computing device. In one embodiment, two or more electronic storage cards are removably coupled to the electronic circuit board riser and are in a RAID. Further the controller is a RAID controller. In another embodiment, the storage device is a solid state storage device.

### RELATED APPLICATIONS

This application claims priority to U.S. Provisional Patent Application Ser. No. 61/558,420 filed Nov. 10, 2011, entitled SYSTEMS AND METHODS FOR PROVIDING A DYNAMIC ELECTRONIC STORAGE UNIT, which is incorporated herein by reference.

### BACKGROUND OF THE INVENTION

1. Field of the Invention

The present invention relates to electronic storage units. More specifically, the present invention relates to modular componentry for dynamic storage of digital data.

2. Background and Related Art

Storage devices retain electronic data after a computer system is powered off, and therefore are used to store computer system files, program files, program updates, user documents, media files, and all other such electronic data that a system or user chooses to retain. Storage units take the form of secondary storage, off-line storage, and network storage. Secondary storage is not accessible by a computer's CPU, but accessed through a computer's input/output channels. A common example of secondary storage includes a hard disk. Other examples include flash drives and floppy disks. Off-line storage is disconnected from a computer system, thus it is not controlled by the CPU of a computer system. Examples of off-line storage include external hard drives, and optical disks.

One common problem with current storage devices is the ever increasing need for more storage space. The single gigabyte hard drive no longer provides sufficient storage space for most modern users. Just about as quickly as new storage units accommodate for larger storage needs, new, more storage-intense programs, media files, and media standards are developed to fill up the new storage space. Updating the storage capacity of a computer system is often difficult and costly. Replacing or adding a system hard drive requires time and expertise.

Another problem with storage devices is reliability. There is an increasing trend for computer users to store their primary music, video, and photographic libraries electronically on storage devices. If these devices fail, a user can lose their entire library of costly media and invaluable family videos and photographs. To overcome this problem, some computer users backup their information on a separate storage device. Such devices might include an optical disk, network location, website, or separate storage device. These methods are time consuming, expensive, and often require a user to purchase double the needed storage space.

Thus, while techniques for digital storage currently exist, challenges still exist. Accordingly, it would be an improvement in the art to augment or even replace current techniques.

### SUMMARY OF THE INVENTION

The present invention relates to electronic storage units. More specifically, the present invention relates to modular componentry for dynamic storage of digital data.

Implementation of the present invention takes place in association with modular electronic storage unit or device having replaceable storage cards. The storage cards are coupled to an electronic circuit board riser. In one implementation, the electronic circuit board riser has a number of slots that receive and hold one or more storage cards. As such, the unit's storage capacity is easily upgraded by removing and replacing any number of the electronic storage cards with updated storage cards. In one embodiment, the storage unit further includes a controller that provides support for communicating between the electronic storage cards and an external computing device.

In one implementation, the storage cards are solid state storage devices, such as flash storage. Solid state storage devices can be inexpensively produced and sold, and utilize low levels of power. In another implementation, the storage device includes a plurality of storage devices that form a Redundant Array of Independent Disks (“RAID”). This RAID configuration increases the reliability and performance of the disk array by providing data redundancy between the plurality of storage devices.

While the methods and processes of the present invention have proven to be particularly useful in the area of personal and network computing, those skilled in the art will appreciate that the methods and processes described herein can be used in a variety of applications and areas of manufacture to yield industrial automation and efficiency.

These and other features of the present invention will be set forth and become more apparent in the description and appended claims that follow. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of a modular storage unit and one storage card according to one embodiment of the present invention;

FIG. 2 illustrates a cross-sectional side view of a modular storage unit with a plurality of storage cards and a controller card according to one embodiment of the present invention;

FIG. 3 illustrates a perspective view of the modular storage unit;

FIG. 4 illustrates a perspective view of an encasement and attached endplate to a modular storage unit according to one embodiment of the present invention;

FIG. 5 illustrates a perspective view of a rack system incorporating a plurality of modular storage units according to one embodiment of the present invention; and

FIGS. 6-7 illustrate representative cards for use in association with at least some embodiments of the present invention.

### DETAILED DESCRIPTION OF THE INVENTION

The present invention relates to electronic storage units. In particular, the present invention relates to a modular storage unit that is easily upgraded, scaled, and interchanged. In addition to providing modular, upgradeable electronic storage, the present invention provides a modular storage unit capable of housing a relatively large quantity of electronic storage units in a relatively small volume as compared to equivalent, non-modular storage units. Furthermore, some implementations of the current modular storage unit comprises high speed read/write capabilities, and is ideally configured to utilize Redundant Array of Independent Disks (“RAID”) technology. As such, the current modular storage unit provides enhanced performance and reliability to the storage unit of a compatible system.

The modular storage unit of the present invention is ideal for use with any computer, computing system, or computer enterprise. In one embodiment, the modular storage unit is used to provide off-line storage to a personal computer. In another embodiment, the modular storage unit is operably coupled to a computer system to provide secondary storage. In yet another embodiment, one or more modular storage unit(s) is used as a storage drive in a network system. In yet another embodiment, the modular storage unit(s) provides storage to a computing system that provides smart functions or automation capabilities to an external unit. One of skill in the art will appreciate that the modular storage unit is useful in nearly all situations, systems, and units in which computing systems and digital data storage are utilized.

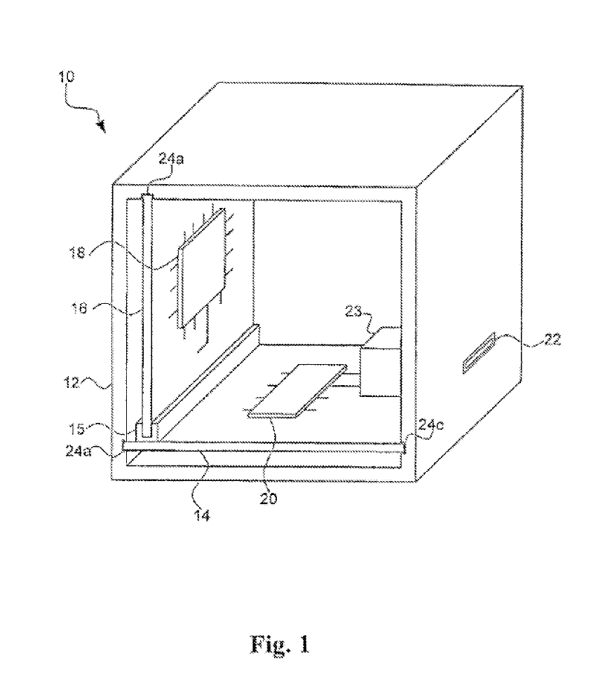

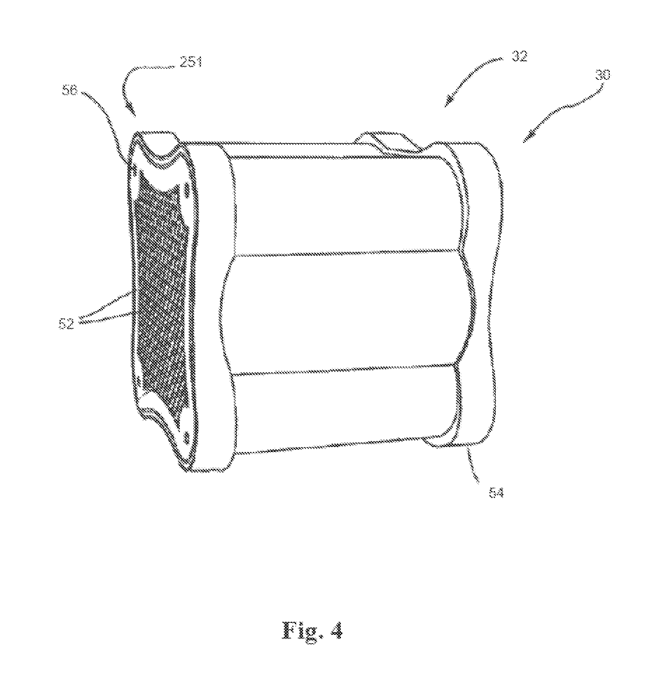

Referring now to FIG. 1, a modular storage system 10 includes an encasement 12 that houses an electronic circuit board riser 14 and an electronic storage card 16. In one embodiment, the encasement 12 includes one or more receiving channels 24a, 24b, and 24c for receiving the riser 14 and the storage card 16. In other embodiments, the encasement 12 includes other means for holding the riser 14 and the storage card 16 in place. For example, in one embodiment the encasement 12 is secured to these devices 14 and 16 with screws, glue, clips, or another suitable fastener known to one of skill in the art. The encasement 12 further comprises an endplate or faceplate 51, as shown in FIG. 4. In one embodiment, the faceplate 51 is removable, thereby allowing a user to easily access the various components housed within the encasement 12.

In some implementations of the current invention, the storage card 16 is removably coupled to riser 14. The riser 14 includes a slot 15 that is sized and configured to receive a compatible storage card 16. The slot 15 is directly coupled to an upper surface of the riser 14 opposite a receiving channel 24a of the encasement 12. As such, opposing edges of the storage card 16 are inserted into the channel 24a and the slot 15 thereby securing the storage card 16 within the encasement 12. The slot 15 provides mechanical support to the storage card 16 thereby preventing unintended removal of the storage card 16 from the incasement 12. For example, in one embodiment the slot comprises a locking mechanism to engage a portion of the storage card 16 and prevent removal of the storage card 16 therefrom. In another embodiment, a connector is employed to connect the storage card to the riser thereby providing mechanical and electrical support to the storage card 16. In some embodiments, the riser includes a plurality of slots thus providing support for a plurality of storage cards. In some implementations of the current invention, the riser 14 further includes a bus system for providing communication between the controller 20 and the storage card 16.

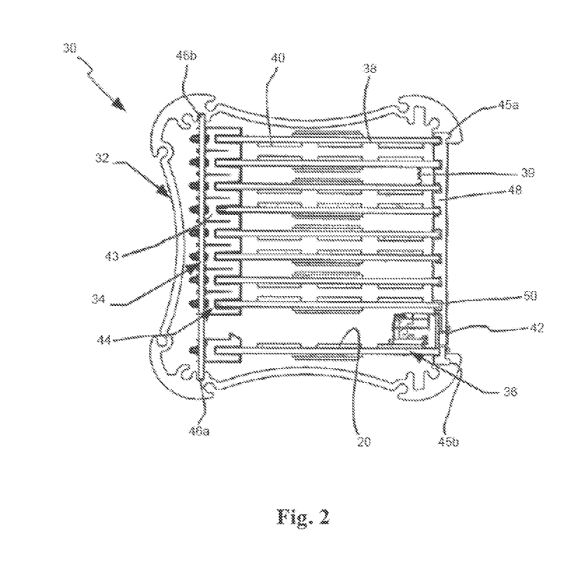

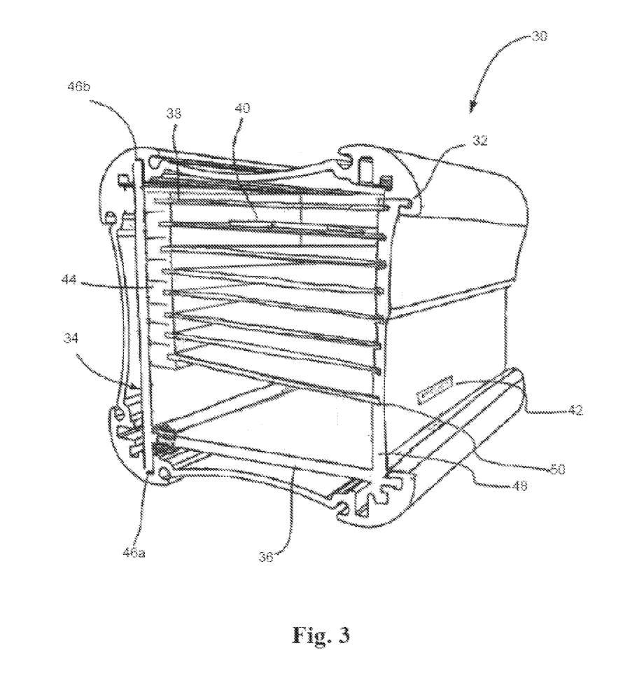

As configured, the storage card 16 is removeably coupled to the riser 14 and the channel 24a of the encasement 12. As such, the storage card 16 is easily removed from the encasement 12 for replacement and upgrading. For example, where a user desires to upgrade the modular storage system 10, the user removes the storage card 16 from the encasement 12 and replaces the storage card 16 with a desired storage card 16. Alternatively, the user may upgrade the modular storage system 10 by retaining the storage card 16 and inserting additional a second storage cards into the encasement 12, as shown in FIGS. 2 and 3. Thus, the modular storage system 10 is capable of modular upgrades, as required by a user. This configuration permits a user to upgrade the performance and storage capacity of the system 10 without discarding the entire system 10, or costly components thereof.

In some embodiments, the storage card 16 comprises a substrate, such as an electronic circuit board, one or more storage devices 18, and an internal bus system. The electronic circuit board and internal bus system include the necessary structures for reading and writing to the storage device(s). The storage card 16 further includes means for coupling to the riser 14, as discussed in detail below. The storage cards internal bus system establishes a connection between the storage devices 18 and the riser 14 via the connection means.

The storage card 16 can include various types of storage devices. For example, in some embodiments the storage device is a solid state memory device, such as a flash storage device. The dimensions of the storage card are configured to compatibly fit within the restricted dimensions of the encasement 12. For example, in one embodiment the dimensions of the storage card 16 are approximately 63.5 mm×76 mm×2.5 mm. In another embodiment, the dimensions of the storage card are configured relative to the dimensions of the encasement 12.

Solid state memory devices provide a number of advantages to the modular storage device 10. For example, solid state memory devices produce low levels of heat dissipation. Typically, storage devices enclosed within an encasement produce high levels of heat thereby requiring an active cooling system. However, solid state storage devices produce low levels of heat thereby negating the need to include an active cooling system in the encasement 12. Rather, the minimally produced heat from the storage devices 18 may be effectively removed from the system 10 by natural convection and dissipation into the surrounding environment of the system 10. In one embodiment, natural convection of the system 10 is accomplished by providing a plurality of vents or holes 52, as shown in FIG. 4. In addition to minimal heat production, solid state memory devices are also small and capable of high storage capacity. Solid state memory is free from moving parts, which further reduces energy consumption and noise production.

One particular advantage of the modular storage unit 10 is that a user can easily remove and replace a current storage card with another storage card. Traditional storage units require a user to upgrade the entire storage unit rather than replacing one or more storage cards of the storage unit. With continued reference to FIG. 1, the implementation shown allows a user to slideably remove the riser 14 and the storage card 16 from the receiving channels 24a, 24b, and 24c. As such, the user is permitted to disconnect the storage card 16 from the riser 14 and replace the storage card 16 with a new storage card. The user then reinserts the new storage and riser 14 into the encasement, thereby upgrading the modular memory system 10. In this manner, a user quickly upgrades the modular storage unit 10 without needing to purchase an entire unit. This method of upgrading is also accomplished with the modular storage unit 30, as shown in FIGS. 2 and 3.

In some embodiments, the riser 14 includes a controller 20 that connects with a port 22 having an internal structure 23. The port 22 allows the storage system 10 to connect to and communicate with an external computing device or system. The controller 20 controls data read and written to the storage card 16. In one embodiment, the controller 20 is a single processing chip. In another embodiment, the controller 20 comprises a plurality of computing components. In another embodiment, the controller 20 is entirely coupled to the riser 14. In yet another embodiment, as shown in FIG. 2, the controller 20 is a controller card 36, which is removably coupled to the riser 34, via a slot 44.

The controller 20 presents the storage card 16 to an external device or external computer system as a logical unit. In some embodiments, two or more storage cards are included in the modular storage system 10. The controller manages the storage cards 16 and presents them to an external computing system as logical units or as a single logical unit. In some embodiment, the controller 20 acts as a disk array controller and treats the two or more storage cards 16 as separate disks in a disk array.

Referring now to FIGS. 2 and 3, embodiments of a modular storage unit 30 are shown. The modular storage unit 30 includes an encasement 32, a removable backplane 48, receiving channels 46a and 46b, a riser 34, a controller card 36, and a plurality of storage cards 38. In one embodiment, the backplane is fixedly attached to a portion of the encasement 32. The encasement 32 houses the riser 34, which riser 34 is interconnected to the plurality of storage cards 38. The encasement 32 and backplane 48 include the several receiving channels 46a, 46b, and 50 for removably securing the assembly of the riser 34 and plurality of storage cards 38. In one embodiment, the riser 34 includes a plurality of slots 44 which are configured to receive a plurality of storage cards 38. In one embodiment, the riser 34 includes between two and ten slots. In other embodiments, the riser 34 includes more than ten slots. As shown in FIG. 2, the riser 34 includes eight slots for receiving eight storage cards 38 and single slot for receiving a controller card 36.

The storage card 38 includes at least one electronic storage device 40. In some embodiment, the storage card 38 includes a plurality of storage devices 40. For example, in one embodiment a single storage card includes between two and sixteen storage devices 40. In other embodiments, the storage device 40 includes more than sixteen storage devices 40. Various types of storage devices 40 can be used in the storage unit 30. In some embodiments, the storage devices 40 are solid state devices, such as flash storage device. In other embodiments, a magnetic or optical storage device is used. A gap 39 is included between the storage cards 38 to facilitate airflow and heat dissipation within the system 30.

In one embodiment, the storage card 38 includes an edge contact that is received in a slot 44. The edge contact includes a number of metallic contact pads positioned on or near the edge of the storage card 38. The metallic contact pads provide a contact surface for establishing electrical communication between the card 38 and the slot 44 when the card 38 is inserted within the slot 44. In one embodiment, the edge contact includes either copper or aluminum contact pads. In another embodiment, the edge contact is a single edge contact. In yet another embodiment, the edge contact is a multi-edge contact.

In one embodiment, the storage unit 30 includes a riser 34 having a plurality of slots 44. Each slot is configured to compatibly receive a storage card 38 having a plurality of solid state flash storage devices 40. In one embodiment, each storage device 40 is approximately 8 gigabytes (Gb). Thus, the storage capacity of each card 38 is approximately 128 Gb, and the combined storage capacity of the storage system 30 is approximately 1 terabyte (Tb). In one embodiment, the dimensions of the storage cards 38 are approximately 3″×2.5″×⅛″ and the dimensions of the encasement are approximately 3.5″×3.5″×3.5″. Each storage card utilizes approximately 4 watts of power to operate under normal conditions such that eight storage cards use approximately 32 watts of power. As such, the heat dissipated by a controller is minimal, as previously discussed. Because the storage devices 40 draw low levels of power, the system 30 produces low levels of heat. Thus, the heat produced by the storage devices 40 can be naturally dissipated without requiring an additional active cooling system, as discussed above.

In some embodiments, the controller is a controller card 36. The controller card 36 includes the necessary components needed to control the attached storage cards 38 and present them to external computing systems as logical units. In some embodiments, the controller 20 is included on the riser 14, as shown in FIG. 1. Alternatively, the controller card 36 is coupled to the riser 34 indirectly via a slot 44 and edge contact connection. One of skill in the art will recognize that a number of other coupling methods may be effectively used to couple the controller card to the electronic circuit board.

In some embodiments, the controller card 36 is a RAID controller. The RAID controller treats each attached storage card 38 as a separate storage card in an array, but presents the group of storage cards as a single storage location to an external computing system. RAID technology simultaneously uses two or more storage disks or cards to achieve greater performance and reliability than can be achieved using a single drive or card. RAID strips, mirrors, and creates parity of data to accomplish these benefits. These processes and calculations are implemented with a RAID controller, as understood in the art.

The RAID controller divides and replicates data among several drives, disks, or cards to increase the input/output performance and the reliability of the storage array. In one instance RAID technology creates parity information by performing bitwise XOR functions on the data from two or more drives and stores that information as parity information. If any drive fails, the information from that drive can be constructed by performing another bitwise XOR function on the data from the remaining drive and the parity information. The result of this function recreates the lost information on the failed drive. This recreated information can thus be reconstructed and restored on a replacement drive.

RAID includes a number of different computer data storage schemes, which are referred to by level, such as: zero level RAID, first level RAID, sixth level RAID, etc. Each RAID level implements a unique data storage scheme, and each can be used by the controller 36 in different embodiments. In addition to the standard RAID levels (0-6), non-standard RAID levels, and nested RAIDs can be incorporated with the controller 36 in different embodiments.

In one embodiment, the controller 36 is a level five RAID controller. RAID five uses block-level striping with parity data distributed across all the included storage cards. Striping involves designating a collective series of blocks of data on each drive, disk, or card as a “stripe.” So, for example, if four storage cards are in a RAID, each card may be divided into four data blocks, and the first data blocks of each card are collectively a stripe. Likewise, each second block of each card form a second stripe, and so on to the forth block of each card. With RAID five, each card will store parity information in one of its data blocks. For example, with four striped cards the first block of the first card may be a parity block, which stored parity information for the other blocks on that stripe. Likewise, the second block of the second card, the third block of the third card, and the forth block of the forth card may be dedicate to storing parity information for their respective stripes. When data is written to any block or a portion of any block, the parity block corresponding to that stripe is recalculated. Continuing the example, if data is written to the first block on the second card, the parity block (stored on the first block of the first card) is recalculated. Thus, the entire storage system maintains up-to-date parity information of the entire contents of each drive. When data is read from a block, the parity data corresponding to that block is not read, for efficiency. Whiles these examples are provides as mere illustrations, it will be understood by one of skill in the art that a level five RAID embodiment can incorporate any striping structure, and any number or positioning of parity blocks.

In some embodiments, the controller card 36 is easily removed and replaced to change the function of the modular storage unit 30. The controller card 36 is removably coupled to the riser 34 thereby facilitating easy removal and replacement of the card 36. In some embodiment, the controller card 36 is specifically configured to function in a particular network system. For example, in one embodiment, the controller card is specifically configured as a network attached storage (NAS) controller card. In this example, the controller card 36 includes a serial ATA (SATA) port. In one embodiment, the SATA port includes four or more communication lines that allow for high speed read/write capability. In another embodiment, the controller card 36 is configured as a storage attached network (SAN) unit and includes a fiber optic port, such as a fiber channel port. In another embodiment, the controller card 36 is configured as an off-line external storage unit having an Ethernet port or USB port. In yet another embodiment, the controller card 36 includes two or more different kinds of ports. One of skill in the art will recognize that the controller card 36 can be configured to allow the modular storage unit to accommodate a variety of network and port types.

In some embodiments, the backplane 48 is removable coupled to the encasement 32. In one embodiment, the encasement 32 includes channels 45a and 45b that receive the backplane 48 in a reversible fashion. A user may desire to replace the backplane 48 for a variety of reasons. For example, in one embodiment a user replaces the backplane 48 to accommodate a different type of port 42, as the backplane includes an aperture or location for holding a port 42. In another embodiment, the backplane 48 includes a port for connecting to a power cable or power supply. In another embodiment, the backplane 48 includes a power cable that plugs into a power outlet. In yet another embodiment, the backplane 48 includes wireless capabilities that enable the system 30 to send and receive wireless signals from another computing system or like device.

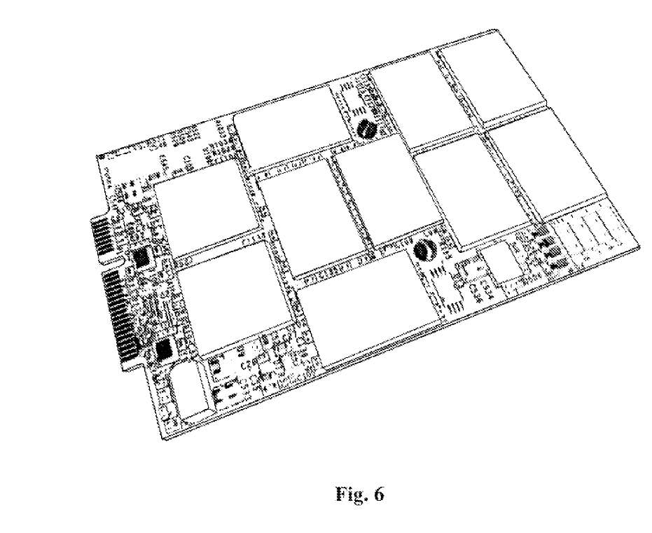

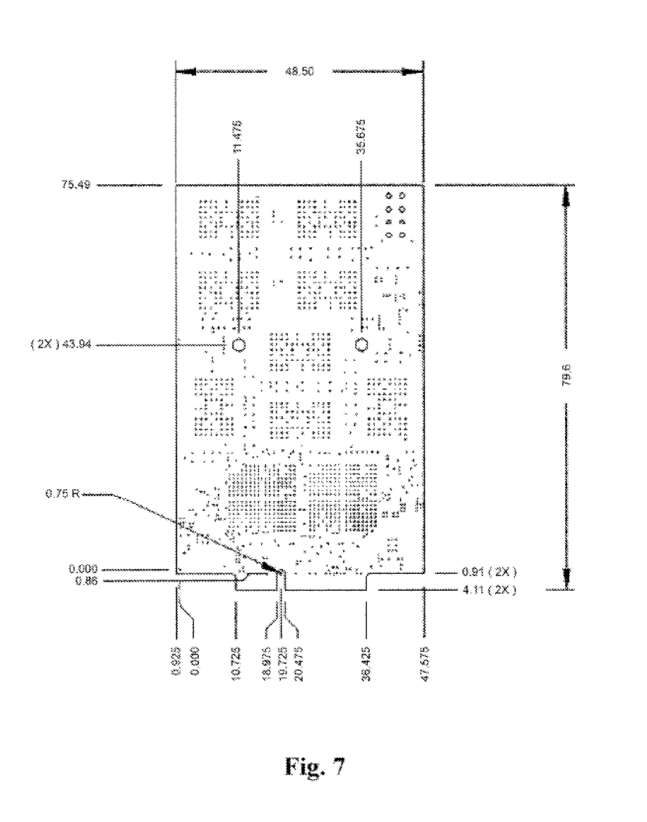

With reference now to FIGS. 6-7, representative cards for use in association with at least some embodiments of the present invention are illustrated. At least some embodiments utilize surface mount technology on one or more sides of a card. At least some embodiments embrace a plurality of drives. In at least some embodiments, each drive includes a controller and a memory array. Thus, as will be discussed below, throughput is increased by the utilization of a plurality of drives on a given card. Throughput is further increased by the utilization of a plurality of cards.

Referring now to FIG. 4, a perspective view of an encasement 32 of a modular storage unit 30, is shown. The encasement 32 includes two endplates 51 and 54. In one embodiment, endplate 51 includes a plurality of vents 52. In another embodiment, both endplates 51 and 54 include a plurality of vents 52. The vents 52 allow ambient air to travel in and out of the encasement 32 to facilitate a natural convection cooling system, as previously discussed. The endplates 51 and 54 include a plurality of screw holes 56 for securing the endplate to encasement 32 with fasteners. Replacement or modification of any component of the modular storage unit 30 is accomplished by removing at least one of the endplates 51 and 54 to access the inner components of the unit 30.

In some embodiments, the system 30 comprises a full metal encasement 32 that is structured and designed to provide an extremely strong support structure for modular unit 30 and the components contained therein. In one embodiment, the encasement 32 is made of aluminum. Under normal circumstances, and even extreme circumstances, encasement 32 is capable of withstanding excessive applied and impact forces originating from various external sources. Specifically, the encasement 32 is preferably built entirely out of radiuses, wherein almost every structural feature and element of the encasement 32 comprises a radius. This principle of radiuses functions to transfer any load applied to the modular storage unit 30 to the outer edges of unit 30. Therefore, if a load or pressure is applied to the top of encasement 12, the load is transferred along the sides, into the top and base, and eventually into the corners of encasement 32.

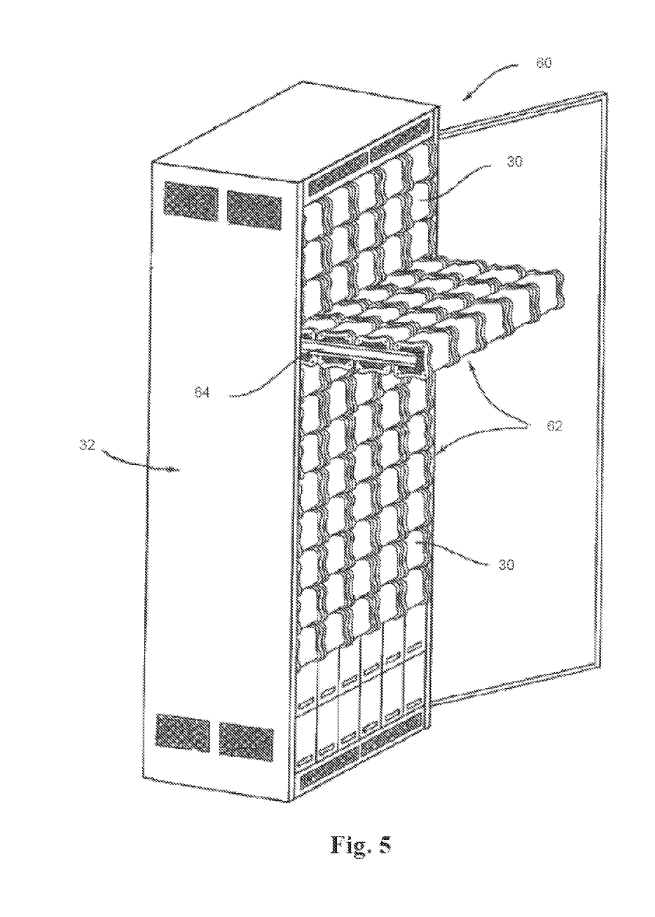

In some embodiments, two or more modular storage units are coupled together to form a storage enterprise or system of racks 60, as shown in FIG. 5. The system of racks 60 accomplishes an advantage of what may be termed as “scaled storage” configuration. Specifically, FIG. 5 illustrates multi-plex storage center 60 (shown as a tower) that comprises a cluster or a plurality 62 of individual modular storage units 30, each storage unit 30 coupled together and mounted within multi-plex storage center 60. Each individual storage unit 30 is mounted within the storage center 60 using a suitable means. For example, in one embodiment the individual storage units 30 are mounted to an integrated rack system 64 of the storage center 60. The rack system 64 comprises engagement means thereon to physically and removably couple each storage unit 30 thereto. Engagement means preferably comprises a mounting bracket designed to attach to and fit within the walls of the encasement module 32. Additionally, the engagement means comprise a systems of bearings or rollers to permit the engagement means and the coupled storage units 30 to remove outwardly from the encasement module 32. As shown, it is contemplated that any number of storage units 30 may be coupled together to achieve scaled storage capability in a very limited amount of space. In some embodiments, each of the storage units 30 of the plurality 62 is in a RAID configuration. In one embodiment, the plurality 62 of units 30 includes a separate RAID controller for controlling the storage units, which treats each unit 30 as a separate drive.

Scaled storage capabilities may be defined as the overall storage ability of a cluster of modular storage units 30. Moreover, scaled storage capability is directly proportional to the number of units electrically process-coupled together.

As a multi-plex center 60 is not always desirable, two or more storage units 30 may nonetheless be coupled together to form a storage enterprise 60. Such a combination can quickly provide additional storage to a storage unit 30 without requiring a user to replace the existing storage unit 30. In one embodiment, a proprietary universal port is provided to physically and electrically couple multiple modular storage units 30 together. One of ordinarily skilled in the art will recognize the various ports that may be utilized with the processing control unit of the present invention. When connected together the two storage units 30 have a combined storage capabilities and provide scaled storage as identified and defined herein. In one embodiment, the universal port connects to the controller 36, similar to port 42. In another embodiment, the universal port connects directly to the bus system of the riser 34.

In another embodiment, two or more storage units 30 may be coupled together without requiring them to be physically coupled to each other. As such, two or more storage units may be process coupled using a wired or wireless connection. Such a wired connection may include a connection wire or cable that connects to the port 42 or universal port of each storage unit 30. In one embodiment, when two storage units 30 are connected, the combined unit is controlled by only one controller 36 in the combination. In another embodiment, each of the storage cards of the combined storage units 30 is a RAID, and controlled by a single controller 36. In another embodiment, the combined storage units 30 each are in a RAID, wherein each storage unit 30 acts like a storage drive in a RAID configuration.

In at least some embodiments of the present invention, throughput is increased by utilization of systems and methods of the present invention. By way of example, a printed circuit board assembly (PCBA) is provided having multiple drives. In some embodiments, multiple drives are located on a PCBA. In some embodiments, one or more drives are located on one side of a PCBA and/or one or more drives are located on another side of the same PCBA, such that the PCBA includes multiple drives per card.

Thus, in accordance with at least some embodiments of the present invention, two or more drives are provided per card. In one embodiment, a card includes 6 Gig throughput through a drive on the top of the card and 6 Gig throughput through a drive on the bottom of the card. Therefore the card provides 12 Gig throughput. Further, if 10 such cards are used, then the device provides 120 Gig of throughput.

Thus, in at least some embodiments of the present invention, throughput is increased by utilization of systems and methods of the present invention. Throughput is increased by the utilization of a plurality of drives on a given card. (Thus, at least some embodiments of the present invention embrace the utilization of two or more drives per card.) Throughput is further increased by the utilization of a plurality of cards per device. Moreover, throughput is further increased by utilization of multiple devices.

Those skilled in the art will appreciate that each drive can include more or less than 6 gig. Therefore, each card can provide more or less than 12 Gig. Moreover, embodiments of the present invention embrace systems that include more or less than 10 cards, therefore having more or less than 120 Gig of throughput at the backplane per device. Furthermore, embodiments of the present invention embrace utilization of a plurality of devices to further increase throughput.

Utilization of embodiments of the present invention provide a variety of efficiencies. For example, efficiencies are experienced relating to space, layout, heat distribution, etc. Further efficiencies are experienced by laying out equal sets of drives. Efficiencies are experienced using multiple drives on a card, having multiple drives on the top of a card, having multiple drives on the bottom of a card, stacking cards, and/or stacking devices. Utilization of multiple drives per card and signaling technology, such as RAID or another signaling technology, allows for the multiple drives to look like one drive. Therefore, multiple drives can be used as one single drive.

Embodiments of the present invention provide miniaturization, duplication, and the creation of speed at the drive level.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A modular electronic storage unit comprising:
an electronic circuit board riser;
an electronic storage card having a storage device, the electronic storage card being removably coupled to the electronic circuit board riser and being in communication with the electronic circuit board riser; and
a controller coupled to the electronic circuit board riser, wherein the controller provides support for communicating between the electronic storage card and an external computing device.

2. The modular electronic storage unit of claim 1, wherein the electronic storage card comprises at least two electronic storage cards, and wherein the at least two electronic storage cards are in a Redundant Array of Independent Disks (RAID), and wherein the controller is a RAID controller.

3. The modular electronic storage unit of claim 2, where in the RAID is a level five RAID.

4. The modular electronic storage unit of claim 1, wherein the electronic storage card include a solid state storage device.

5. The modular electronic storage unit of claim 4, wherein the electronic storage card includes a flash storage device.

6. The modular electronic storage unit of claim 1, wherein the electronic storage card includes only solid state storage devices.

7. The modular electronic storage unit of claim 1, wherein the controller comprises a controller card.

8. The modular electronic storage unit of claim 1, wherein the controller includes a port for connection with the external device.

9. The modular electronic storage unit of claim 1, wherein the controller supports the modular electronic storage unit as at least one of the following:
(i) a storage device on a storage area network;
(ii) network attached storage; and
(iii) an external storage drive.

10. A modular electronic storage device comprising:
an electronic circuit board riser having means for receiving an electronic storage card, the electronic circuit board riser having a bus system;
an electronic storage card having a storage device and being received in the means for receiving an electronic storage card riser and being in communication with the bus system; and
a controller coupled to the bus system, wherein the controller provides support for communicating between the electronic storage card and an external device.

11. The modular electronic storage device of claim 10, wherein the electronic storage card comprises at least two electronic storage cards, and wherein the controller is a Redundant Array of Independent Disks (RAID) controller and the at least two electronic storage cards are in a RAID.

12. The modular electronic storage device of claim 10, wherein the storage device is a solid state storage device.

13. The modular electronic storage device of claim 10, wherein the storage device is a flash storage device.

14. A modular electronic storage enterprise comprising:
a first modular electronic storage unit having a first electronic circuit board riser, the first electronic circuit board riser having a first bus system, and having a first electronic storage card operably coupled to the first electronic circuit board riser, and having means for establishing a connection between the first bus system and another modular electronic storage unit; and
a second modular electronic storage unit having a second electronic circuit board riser, the second electronic circuit board riser having a second bus system, and having a second electronic storage card operably coupled to the second electronic circuit board riser, and having means for establishing a connection between the second bus system and the first modular electronic storage unit.

15. The modular electronic storage enterprise of claim 14, wherein the first and second modular electronic storage units comprise part of at least one of the following electronic storage schemes:
(i) network attached storage (NAS); and
(ii) storage access network (SAN).

16. The modular electronic storage enterprise of claim 14, wherein the first and second electronic storage card include a solid state storage device.

17. The modular electronic storage enterprise of claim 14, wherein the first and second electronic storage card include a flash storage device.

18. The modular electronic storage enterprise of claim 14, wherein the first modular electronic circuit board riser further includes a third electronic storage card operably coupled to the first electronic circuit board riser, and wherein the first and third electronic storage cards are in a Redundant Array of Independent Disks (RAID).

19. The modular electronic storage enterprise of claim 18, wherein the first means for establishing a connection includes a RAID controller.

20. The modular electronic storage enterprise of claim 14, wherein the first and second modular electronic storage units are in a RAID.
